(19) United States
(12) Patent Application Publication
(10) Pub. No.: US 2018/0272995 A1
(43) Pub. Date: Sep. 27, 2018

(54) VEHICULAR WASHER DEVICE

(71) Applicant: HONDA MOTOR CO., LTD., Tokyo (JP)

(72) Inventors: Takeshi Sasaki, Wako-shi (JP); Motoki Minami, Wako-shi (JP); Takuro Hashimoto, Wako-shi (JP); Taisuke Goto, Wako-shi (JP)

(21) Appl. No.: 15/914,034

(22) Filed: Mar. 7, 2018

(30) Foreign Application Priority Data
Mar. 21, 2017 (JP) 2017-054990

(51) Int. Cl. B60S 1/52; B60S 1/34; B08B 1/00; B08B 3/04

(52) U.S. Cl. CPC B60S 1/522; B60S 1/3415; B60S 1/3488; B08B 3/04; B08B 1/005

(57) ABSTRACT

A distribution apparatus installed in a washer liquid passage has an intake passage which reciprocates in a circumferential direction of a circle about a pivot shaft in a linked manner with a wiper arm and to which a washer liquid is supplied, a first ejection passage disposed further outside in a radial direction of the circle than the intake passage and disposed at a position offset toward one side in the circumferential direction with respect to the intake passage, and a second ejection passage disposed further outside in the radial direction of the circle than the intake passage and disposed at a position offset toward the other side in the circumferential direction with respect to the intake passage. A washer nozzle is connected to at least one of the first ejection passage and the second ejection passage.

### CROSS-REFERENCE TO RELATED APPLICATION

Priority is claimed on Japanese Patent Application No. 2017-054990, filed Mar. 21, 2017, the content of which is incorporated herein by reference.

### BACKGROUND OF THE INVENTION

### Field of the Invention

The present invention relates to a vehicular washer device configured to inject a washer liquid to a target surface to be wiped of a vehicle.

### Description of Related Art

A vehicular washer device having a function of switching an injecting direction of a washer liquid according to a pivoting direction of a wiper arm is proposed (for example, see Japanese Utility Model Publication No. H05-25344).

In the vehicular washer device disclosed in Japanese Utility Model Publication No. H05-25344, a wiper arm is pivotably supported on a pivot shaft of a vehicle, and a first washer nozzle configured to inject a washer liquid while being pivotal moved in one direction and a second washer nozzle configured to inject the washer liquid while being pivotal moved in the other direction are installed on the wiper arm. Then, a flow path switching mechanism configured to switch a supply of the washer liquid with respect to the first washer nozzle and the second washer nozzle in accordance with a pivoting direction of the wiper arm is installed on a circumferential region of the pivot shaft.

In the case of the vehicular washer device, when the wiper arm is pivoted in one direction, the washer liquid is injected from the first washer nozzle toward a target surface to be wiped, and when the wiper arm is pivoted in the other direction, the washer liquid is injected from the second washer nozzle toward the target surface to be wiped.

### SUMMARY OF THE INVENTION

However, in the vehicular washer device of the related art, since the passage of the washer nozzle is switched in accordance with a pivoting direction of the wiper arm by the flow path switching mechanism installed on the circumferential region of the pivot shaft, a seal member in sliding contact with a seal surface according to pivotal movement of the wiper arm needs to be installed in the flow path switching mechanism. For this reason, deterioration may occur in the seal member according to the passage of time, and replacement of the seal member may be forced.

An aspect of the present invention is to provide a vehicular washer device capable of realizing injection control of a washer liquid according to an operating direction of a wiper arm while achieving improvement of durability of parts.

A vehicular washer device according to the present invention employs the following configurations.

(1) A vehicular washer device according to an aspect of the present invention includes a wiper arm that reciprocates in a circumferential direction of a circle about a pivot shaft installed in a vehicle; a wiper blade held at the wiper arm and that wipes a target surface to be wiped of the vehicle; a washer nozzle installed on at least one of the wiper arm and the wiper blade and that injects a washer liquid toward the target surface to be wiped; a washer liquid passage that brings a supply part of the washer liquid and the washer nozzle in communication with each other; and a distribution apparatus installed on a portion of the washer liquid passage and that reciprocates in the circumferential direction of the circle in a linked manner with the wiper arm, wherein the distribution apparatus has: an intake passage connected to the supply part of the washer liquid; a first ejection passage disposed further outside in a radial direction of the circle than the intake passage and disposed at a position offset toward a first side in the circumferential direction with respect to the intake passage; and a second ejection passage disposed further outside in the radial direction of the circle than the intake passage and disposed at a position offset with respect to a second side in the circumferential direction with respect to the intake passage, and the washer nozzle is connected to at least one of the first ejection passage and the second ejection passage.

According to the aspect of (1), when the washer liquid is taken into the intake passage of the distribution apparatus from the supply part and the wiper arm is pivoted to the first side in the circumferential direction in this state, the washer liquid is mainly taken into the second ejection passage in the distribution apparatus by an inertial force being applied to the washer liquid. Here, when the washer nozzle is connected to the second ejection passage, the washer liquid is injected toward the target surface to be wiped through the washer nozzle. Meanwhile, when the washer liquid is taken into the intake passage of the distribution apparatus from the supply unit and the wiper arm is pivoted to the second side in the circumferential direction in this state, the washer liquid is mainly taken into the first ejection passage side by the inertial force being applied to the washer liquid. Here, when the washer nozzle is connected to the first ejection passage, the washer liquid is injected toward the target surface to be wiped through the washer nozzle. Accordingly, when the vehicular washer device is employed, a large amount of the washer liquid can selectively flow through any one of the first ejection passage and the second ejection passage due to the inertial force being applied to the washer liquid in the distribution apparatus when the wiper arm is pivoted. Further, when the washer nozzle is connected to only one of the first ejection passage and the second ejection passage, the washer liquid is injected toward the target surface to be wiped only when the wiper arm is pivoted in one direction.

(2) In the aspect of (1), different washer nozzles may be connected to the first ejection passage and the second ejection passage, respectively.

According to the aspect of (2), the washer nozzle configured to inject a large amount of the washer liquid can be switched by the distribution apparatus according to the pivoting direction of the wiper arm.

(3) In the aspect of (2), wherein the washer nozzle connected to the first ejection passage may be configured such that an injecting direction thereof is directed toward the second side in the circumferential direction of the circle, and the washer nozzle connected to the second ejection passage may be configured such that an injecting direction thereof is directed toward the first side in the circumferential direction of the circle.

According to the aspect of (3), a large amount of the washer liquid can be injected in an advancing direction of the wiper arm from the washer nozzle. Accordingly, when the configuration is employed, since the target surface to be wiped can be wiped by the wiper blade immediately after the washer liquid is injected, an amount of the washer liquid remaining after the wiping can be minimized.

(4) In the aspect of (2) or (3), the distribution apparatus may have a first outflow chamber and a second outflow chamber partitioned by a diaphragm and that are in communication with the first ejection passage and the second ejection passage, respectively, a first outflow port to which one of the washer nozzles is connected may be formed in the first outflow chamber, and a second outflow port to which the other washer nozzle is connected may be formed in the second outflow chamber, and the diaphragm may alternatively close the first outflow port and the second outflow port according to a deform displacement of the diaphragm.

According to the aspect of (4), for example, when a large amount of the washer liquid is taken into the first outflow chamber according to an operation of the wiper arm, the diaphragm is pressed by the washer liquid to be deformed and displaced, and the diaphragm closes the second outflow port on the side of the second outflow chamber. In addition, on the other hand, when a large amount of the washer liquid is taken into the second outflow chamber, the diaphragm is pressed by the washer liquid to be deformed and displaced, the diaphragm closes the first outflow port on the side of the first outflow chamber. Accordingly, when the configuration is employed, an outflow of the washer liquid from a washer nozzle opposite a side at which a large amount of the washer liquid is injected can be suppressed.

(5) In the aspect of any one of (1) to (4), an inner wall of at least one of a connecting region from the intake passage to the first ejection passage and a connecting region from the intake passage to the second ejection passage may be configured by a curved surface protruding toward a central side of a passage of the connecting region.

According to the aspect of (5), when the washer liquid is taken to the vicinity of the curved surface of the inner wall, the washer liquid is drawn to the curved surface by the Coanda effect. For this reason, the washer liquid can be efficiently taken into a desired ejection passage in the distribution apparatus.

(6) In the aspect of any one of (1) to (5), the distribution apparatus may include a partition wall configured to partition the first ejection passage and the second ejection passage, and the partition wall may be disposed on an extension line of the intake passage.

According to the aspect of (6), the washer liquid directly flowing through the intake passage abuts the partition wall to change its flow direction. Here, when the wiper arm is pivoted in any one direction, it is easy for the washer liquid to flow unevenly to a side that receives an inertial force.

According to the aspects of the present invention, when the wiper arm is pivoted, since a large amount of the washer liquid can selectively flow to any one of the first ejection passage and the second ejection passage due to an inertial force being applied to the washer liquid in the distribution apparatus, injection control of the washer liquid according to an operating direction of the wiper arm can be realized without using a complex seal structure in which a seal member comes into sliding contact with another member according to an operation of the wiper arm. Accordingly, according to the aspects of the present invention, injection control of washer liquid in accordance with an operating direction of the wiper arm can be realized while achieving improvement of durability of parts.

### BRIEF DESCRIPTION OF THE DRAWINGS

FIG. 1 is a view showing a configuration of a vehicular washer device of an embodiment of the present invention.

FIG. 2 is a front view of a portion of a wiper arm of the embodiment of the present invention.

FIG. 3 is an exploded perspective view of the portion of the wiper arm of the embodiment of the present invention.

FIG. 4 is a partially cut front view of a distribution apparatus of the embodiment of the present invention.

FIG. 5A is a front view of the washer device of the embodiment of the present invention.

FIG. 5B is a schematic cross-sectional view of a distribution apparatus of the washer device of the embodiment of the present invention.

FIG. 6A is a front view of the washer device of the embodiment of the present invention.

FIG. 6B is a schematic cross-sectional view of the distribution apparatus of the washer device of the embodiment of the present invention.

FIG. 7A is a front view of the washer device of the embodiment of the present invention.

FIG. 7B is a schematic cross-sectional view of the distribution apparatus of the washer device of the embodiment of the present invention.

FIG. 8A is a front view of the washer device of the embodiment of the present invention.

FIG. 8B is a schematic cross-sectional view of the distribution apparatus of the washer device of the embodiment of the present invention.

FIG. 9 is a schematic cross-sectional view of a distribution apparatus of another embodiment of the present invention.

FIG. 10 is a schematic cross-sectional view of the distribution apparatus of the other embodiment of the present invention.

FIG. 11 is a schematic cross-sectional view of the distribution apparatus of the other embodiment of the present invention.

### DETAILED DESCRIPTION OF THE INVENTION

Hereinafter, embodiments of the present invention will be described with reference to the accompanying drawings.

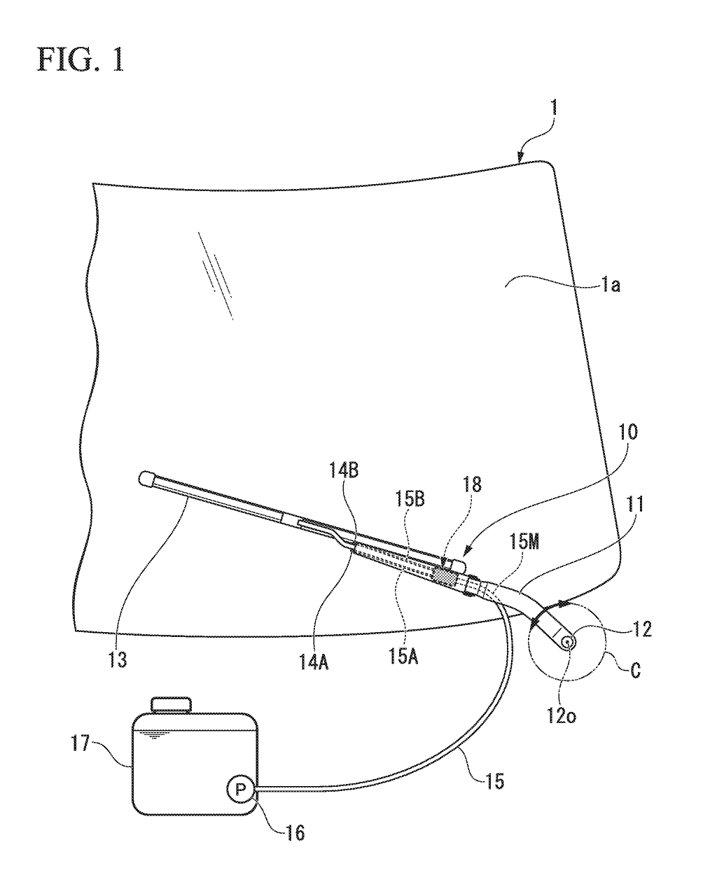

FIG. 1 is a front view of a portion of a windshield glass 1 of a front side of a vehicle that employs a washer device 10 for a vehicle according to the embodiment (hereinafter, referred to as the “washer device 10”).

Left and right wiper arms 11 of a wiper are disposed at left and right separated positions of a lower edge of the windshield glass 1. In FIG. 1, only the left wiper arm 11 of the vehicle is shown. A base section of the wiper arm 11 is pivotably supported on a pivot shaft 12 installed on a vehicle body member under the windshield glass 1. A wiper blade 13 configured to wipe an outer surface 1a (a target surface to be wiped) of the windshield glass 1 is held at a tip portion of each of the wiper arms 11. A biasing mechanism configured to bias the wiper blade 13 toward the outer surface 1a of the windshield glass 1 is installed in the wiper arm 11.

Further, the wiper arm 11 reciprocates about an axial center 12o of the pivot shaft 12 in a circumferential direction of a circle C, as shown by a solid arrow in the drawing.

A first washer nozzle 14B (a washer nozzle) and a second washer nozzle 14A (a washer nozzle) configured to inject a washer liquid toward the outer surface 1a of the windshield glass 1 are attached to the tip portion of the wiper arm 11. The first washer nozzle 14B and the second washer nozzle 14A are connected to a pump 16 serving as a supply unit for the washer liquid through a washer liquid passage 15. The washer liquid stored in a reservoir tank 17 is pumped to the washer liquid passage 15 by the pump 16.

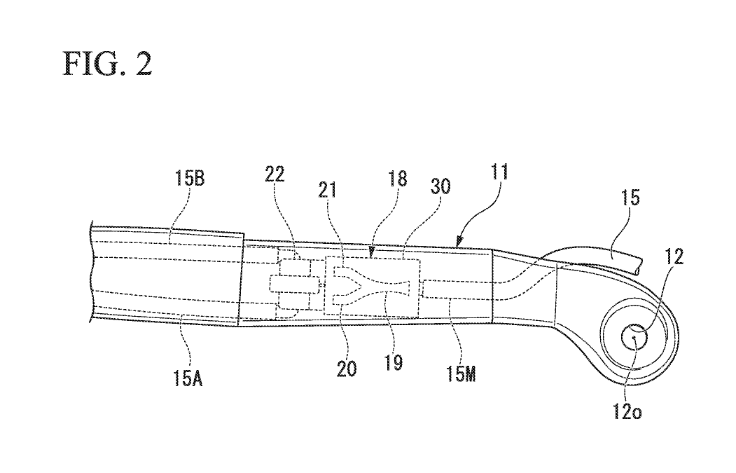

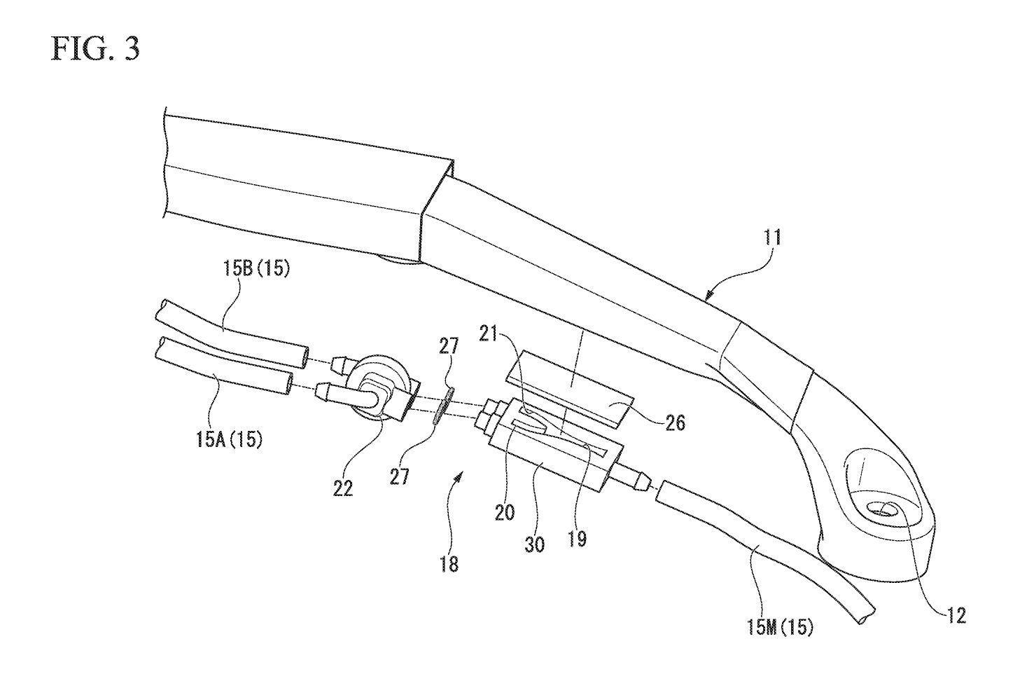

FIG. 2 is a view showing a portion of the wiper arm 11 on the side of the base section when seen in a front view, and FIG. 3 is an exploded perspective view of the portion of the wiper arm 11 on the side of the base section.

As shown in the drawings, a distribution apparatus 18 of the washer liquid is installed in the wiper arm 11. The distribution apparatus 18 is installed in the middle of the washer liquid passage 15. In addition, the distribution apparatus 18 is displaced integrally with the wiper arm 11 and linked to the wiper arm 11 to reciprocate in the circumferential direction of the circle C (see FIG. 1).

The distribution apparatus 18 includes a main body block 30 to which a main pipeline 15M of the washer liquid passage 15 on the side of the pump 16 is connected, and a joint block 22 to which a first branch pipeline 15A and a second branch pipeline 15B of the washer liquid passage 15 on the side of the washer nozzles are connected. The second washer nozzle 14A is connected to the first branch pipeline 15A, and the first washer nozzle 14B is connected to the second branch pipeline 15B.

Further, reference numeral 26 in FIG. 3 designates a cover member configured to close a side portion of the main body block 30, and reference numeral 27 is a seal member configured to seal a periphery of a passage section of a connecting section of the joint block 22 to the main body block 30.

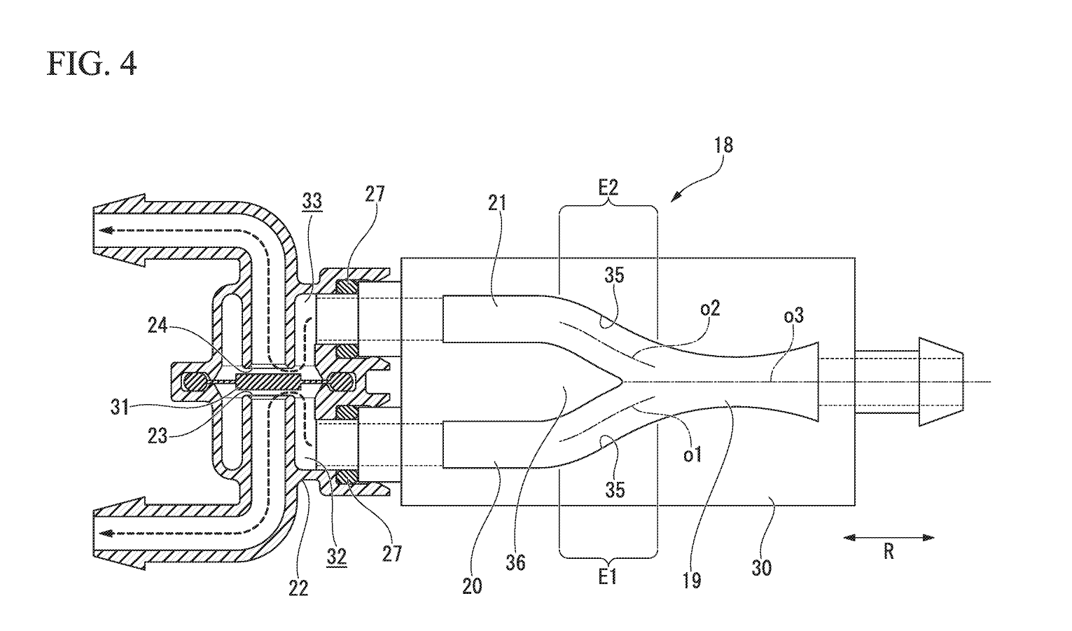

FIG. 4 is a partially cut front view of the distribution apparatus 18 in which the cover member 26 is removed from the main body block 30 and the joint block 22 is cut in a cross section.

As shown in FIG. 4, the main body block 30 has an intake passage 19 having an upstream section connected to the main pipeline 15M of the washer liquid passage 15, and a first ejection passage 20 and a second ejection passage 21 branched from the intake passage 19 in a bifurcated shape. The first ejection passage 20 is located outside in a radial direction R of the circle C about the pivot shaft 12 and disposed at a position offset toward one side (a first side) in the circumferential direction of the circle C with respect to the intake passage 19 in a state in which the distribution apparatus 18 is attached to the wiper arm 11. On the other hand, the second ejection passage 21 is located outside in the radial direction R of the circle C about the pivot shaft 12 and disposed at a position offset toward the other side (a second side) in the circumferential direction of the circle C with respect to the intake passage 19 in a state in which the distribution apparatus 18 is attached to the wiper arm 11.

As shown in FIG. 4, the intake passage 19 extends in the radial direction R of the circle C in the main body block 30, and the first ejection passage 20 and the second ejection passage 21 are branched to be gently curved in opposite directions from an end portion of the intake passage 19. Specifically, an inner wall, which is located at an outer side in the circumferential direction of the circle C, of a connecting region E1, which is a region between the intake passage 19 and the first ejection passage 20, and an inner wall, which is located at an outer side in the circumferential direction of the circle C, of a connecting region E2, which is a region between the intake passage 19 and the second ejection passage 21, are respectively constituted by curved surfaces 35 that protrude toward passage axial centers o1 and o2 (passage centers) of the connecting regions E1 and E2.

In addition, the first ejection passage 20 and the second ejection passage 21 of the distribution apparatus 18 are partitioned by a partition wall 36 having a wedge-shaped tip portion facing the intake passage 19. The tip portion of the partition wall 36 is disposed on an extension line of a passage axial center o3 of an intake passage. In addition, the tip portion of the partition wall 36 is disposed at a position overlapping the curved surface 35 of the connecting region E1 on the side of the first ejection passage 20 and the curved surface 35 of the connecting region E2 on the side of the second ejection passage 21 in the radial direction R of the circle C.

The joint block 22 has a first outflow chamber 32 and a second outflow chamber 33 partitioned by a diaphragm 31. The first outflow chamber 32 is disposed at one side (a first side) in the circumferential direction of the circle C about the pivot shaft 12, and the second outflow chamber 33 is disposed at the other side (a second side) in the circumferential direction of the circle C about the pivot shaft 12.

A first outflow port 23 to which the first branch pipeline 15A is connected is formed in the first outflow chamber 32, and a second outflow port 24 to which the second branch pipeline 15B is connected is formed in the second outflow chamber 33.

The first outflow port 23 protrudes toward the inside of the first outflow chamber 32 to face one surface of the diaphragm 31, and the second outflow port 24 protrudes toward the inside of the second outflow chamber 33 to face the other surface of the diaphragm 31. The diaphragm 31 closes the second outflow port 24 when a large amount of the washer liquid is taken into the first outflow chamber 32 and the diaphragm 31 is displaced to be deformed toward the second outflow chamber 33. In addition, the diaphragm 31 closes the first outflow port 23 when a large amount of the washer liquid is taken into the second outflow chamber 33 and the diaphragm 31 is displaced to be deformed toward the first outflow chamber 32. The diaphragm 31 is configured to alternatively close the first outflow port 23 and the second outflow port 24 according to the deform displacement.

In addition, the second washer nozzle 14A connected to the first branch pipeline 15A is configured such that an injecting direction thereof faces the other side (the second side) in the circumferential direction of the circle C about the pivot shaft 12. Meanwhile, the first washer nozzle 14B connected to the second branch pipeline 15B is configured such that an injecting direction thereof faces the one side (the first side) in the circumferential direction of the circle C about the pivot shaft 12.

Here, the washer liquid taken into the intake passage 19 of the distribution apparatus 18 from the pump 16 receives an influence of an inertial force corresponding to a pivoting direction of the wiper arm 11 and is bent in a direction in which an inertial force is applied to flow toward either the first ejection passage 20 or the second ejection passage 21 when the wiper arm 11 is pivoted. When the washer liquid is taken into the first ejection passage 20, the washer liquid is injected onto the windshield glass 1 from the first washer nozzle 14B via the first outflow chamber 32 and the first outflow port 23. Meanwhile, when the washer liquid is taken into the second ejection passage 21, the washer liquid is injected onto the windshield glass 1 from the second washer nozzle 14A via the second outflow chamber 33 and the second outflow port 24.

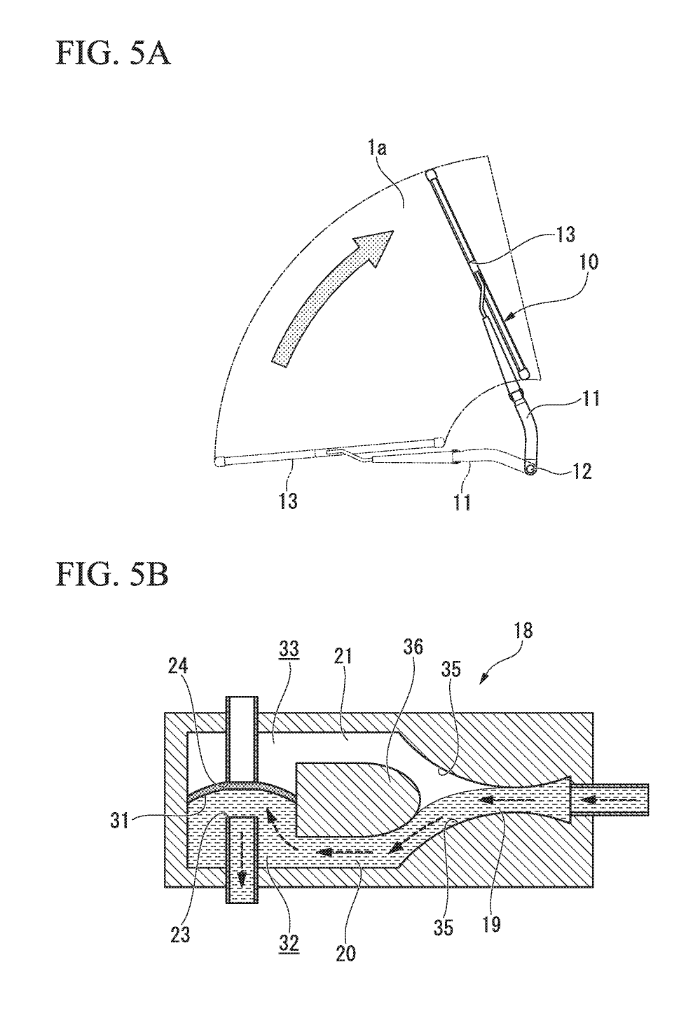

FIGS. 5A to 8B show views showing an operating state of the wiper arm 11 and a flow of washer liquid in the distribution apparatus 18 at this time.

As shown in FIGS. 5A and 5B, when the wiper arm 11 is pivoted from a lower end toward an upper end, an inertial force acting downward in the drawing is applied to the washer liquid in the intake passage 19, and the washer liquid is mainly taken into the first ejection passage 20 side from the intake passage 19 and injected from the first washer nozzle 14B via the first outflow chamber 32 and the first outflow port 23.

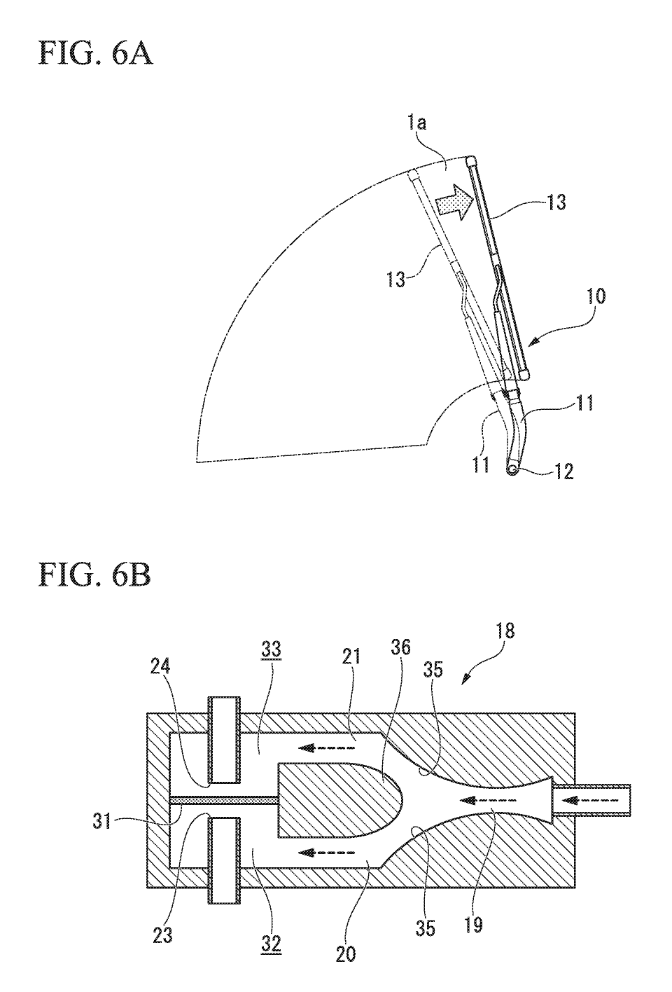

As shown on FIGS. 6A and 6B, when the wiper arm 11 is gradually decelerated and reverses its pivoting direction after the wiper arm 11 is pivoted to the vicinity of the upper end, since the inertial force applied to the washer liquid in the intake passage 19 is decreased or disappears, the washer liquid is substantially evenly divided into the first ejection passage 20 and the second ejection passage 21. Here, the washer liquid is injected from both the first washer nozzle 14B and the second washer nozzle 14A little by little, or the injection from both of the washer nozzles is suppressed without reaching any one of the washer nozzles.

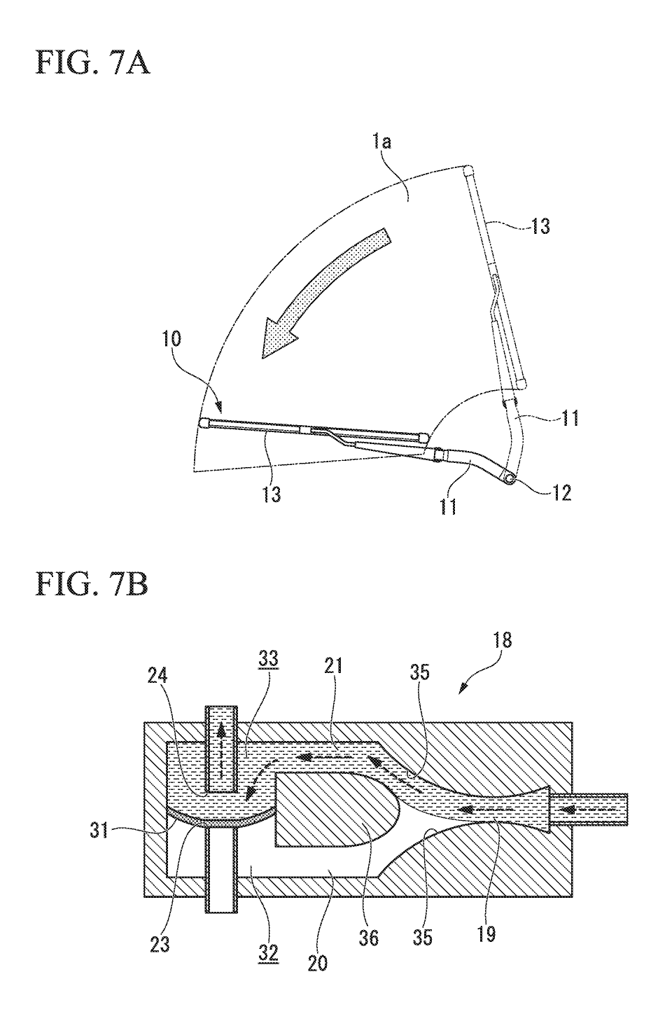

As shown in FIGS. 7A and 7B, when the wiper arm 11 is pivoted from the upper end toward the lower end, the inertial force acting upward in the drawing is applied to the washer liquid in the intake passage 19, and the washer liquid is mainly taken into the second ejection passage 21 side from the intake passage 19 and injected from the second washer nozzle 14A via the second outflow chamber 33 and the second outflow port 24.

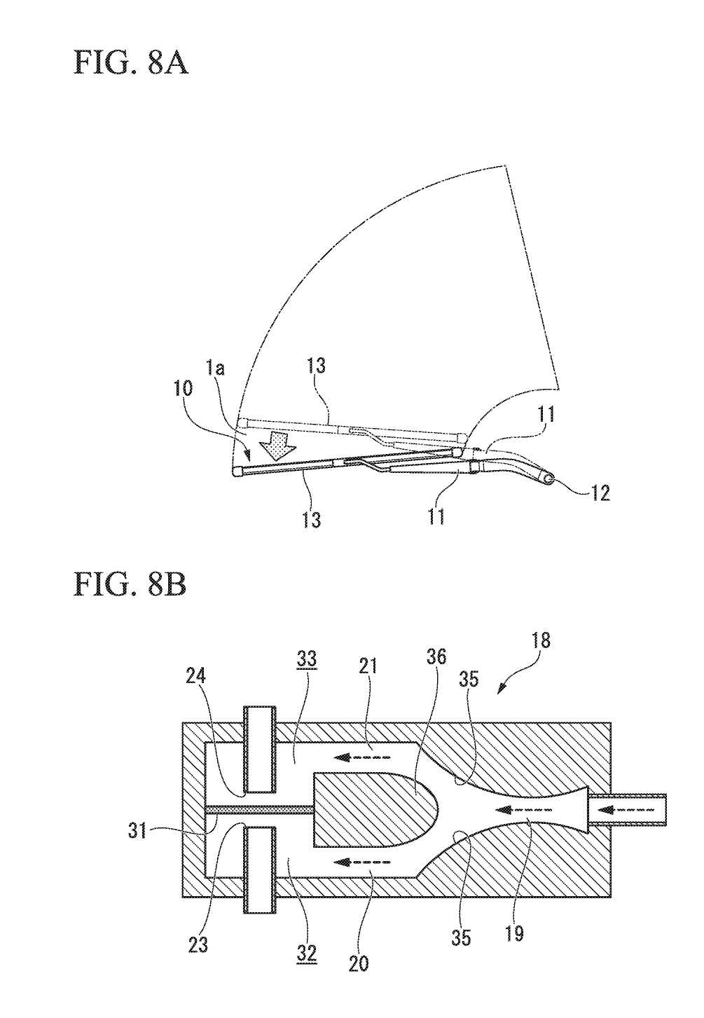

As shown in FIGS. 8A and 8B, when the wiper arm 11 is gradually decelerated to reverse the pivoting direction after the wiper arm 11 is pivoted to the vicinity of the lower end, the inertial force applied to the washer liquid in the intake passage 19 is decreased or disappears. For this reason, the washer liquid is substantially evenly divided into the first ejection passage 20 and the second ejection passage 21 and injected from both of the first washer nozzle 14B and the second washer nozzle 14A little by little, or the injection from both of the washer nozzles is suppressed.

As described above, in the washer device 10 according to the embodiment, the distribution apparatus 18 installed on the wiper arm 11 has the intake passage 19 connected to the pump 16, and the first ejection passage 20 and the second ejection passage 21 branched from the end portion of the intake passage 19 outside in the radial direction R. Then, the first ejection passage 20 is disposed at a position offset toward the one side (the first side) in the circumferential direction about the pivot shaft 12 with respect to the intake passage 19, the second ejection passage 21 is disposed at a position offset toward the other side (the second side) in the circumferential direction about the pivot shaft 12 with respect to the intake passage 19, and the first washer nozzle 14B and the second washer nozzle 14A are connected to the first ejection passage 20 and the second ejection passage 21, respectively. For this reason, when the wiper arm 11 is pivoted, a large amount of the washer liquid can selectively flow to any one of the first ejection passage 20 and the second ejection passage 21 due to the inertial force being applied to the washer liquid in the distribution apparatus 18. In addition, since a seal member in sliding contact with a mating member is not needed in a switching section of a flow path of the washer liquid, less deterioration of parts occur.

Accordingly, when the washer device 10 according to the embodiment is employed, injection control of the washer liquid corresponding to an operating direction of the wiper arm 11 can be realized while achieving improvement of durability of parts.

In addition, in the washer device 10 according to the embodiment, since the first washer nozzle 14B and the second washer nozzle 14A are connected to the first ejection passage 20 and the second ejection passage 21, respectively, the washer nozzle configured to inject a large amount of the washer liquid can be switched by the distribution apparatus 18 according to the operating direction of the wiper arm 11.

However, the washer nozzle may be connected to only any one of the first ejection passage 20 and the second ejection passage 21, and the other ejection passage may be connected to a return pipeline configured to return the washer liquid to the reservoir tank 17. In this case, the washer liquid is injected onto the windshield glass 1 only when the wiper arm 11 is pivotally moved in one direction.

In addition, in the washer device 10 according to the embodiment, the injecting direction of the first washer nozzle 14B is oriented toward an upward pivoting direction of the wiper arm 11, and the injecting direction of the second washer nozzle 14A is oriented toward a downward pivoting direction of the wiper arm 11. For this reason, a large amount of the washer liquid can be injected from one of the first washer nozzle 14B and the second washer nozzle 14A to a side directed in an advancing direction of the wiper arm 11. Accordingly, when the washer device 10 according to the embodiment is employed, an upper surface of the windshield glass 1 can be wiped by the wiper blade 13 immediately after the washer liquid is injected thereto, and an amount of the washer liquid remaining after wiping can be minimized.

Further, the washer device 10 according to the embodiment is configured such that the distribution apparatus 18 has the first outflow chamber 32 and the second outflow chamber 33 formed therein and partitioned by the diaphragm 31, the first ejection passage 20 and the second ejection passage 21 are connected to the first outflow chamber 32 and the second outflow chamber 33, respectively, the first outflow port 23 and the second outflow port 24 are formed, and the diaphragm 31 is formed to alternatively close the first outflow port 23 and the second outflow port 24 according to deform displacement of the diaphragm 31. For this reason, as shown in FIG. 5B, when a large amount of the washer liquid is taken into the first outflow chamber 32 according to an operation of the wiper arm 11, the diaphragm 31 can be pressed by the washer liquid to be deformed and displaced to close the second outflow port 24 on the side of the second outflow chamber 33. In addition, as shown in FIG. 7B, when a large amount of the washer liquid is taken into the second outflow chamber 33 according to the operation of the wiper arm 11, the diaphragm 31 can be pressed by the washer liquid to be deformed and deformed to close the first outflow port 23 on the side of the first outflow chamber 32.

Accordingly, when the washer device 10 according to the embodiment is employed, outflow of the washer liquid from the washer nozzle opposite a side at which a large amount of the washer liquid is injected can be minimized.

In addition, in the washer device 10 according to the embodiment, the inner wall, which is located at an outer side in the circumferential direction of the circle C, of the connecting region E1 of the passage in the distribution apparatus 18 and the inner wall, which is located at an outer side in the circumferential direction of the circle C, of the connecting region E2 are constituted by the curved surfaces 35 protruding toward the passage axial centers of and o2 of the connecting regions E1 and E2. For this reason, when the washer liquid is taken into the distribution apparatus 18 in the vicinity of the curved surface 35 of the inner wall, the washer liquid can be drawn to the inner wall outside in the circumferential direction by the Coanda effect along the curved surface 35 of the inner wall. Accordingly, when the configuration is employed, the washer liquid can be efficiently taken into any one of the first ejection passage 20 and the second ejection passage 21 when the wiper arm 11 is pivoted.

In addition, in the washer device 10 according to the embodiment, the partition wall 36 configured to partition the first ejection passage 20 and the second ejection passage 21 is formed in the distribution apparatus 18, and the partition wall 36 is disposed on the extension line of the passage axial center o3 of the intake passage 19. For this reason, as the washer liquid linearly flowing through the intake passage 19 abuts the partition wall 36, a flow direction of the washer liquid can be easily changed. Accordingly, when the configuration is employed, when the washer liquid in the distribution apparatus 18 receives an inertial force due to a pivotal movement of the wiper arm 11, the washer liquid can efficiently flow through a desired ejection passage.

Further, in the case of the washer device 10 according to the embodiment, the tip portion of the partition wall 36 in the distribution apparatus 18 is disposed at a position overlapping each of the curved surfaces 35 of the connecting region E1 on the side of the first ejection passage 20 and the connecting region E2 on the side of the second ejection passage 21 in the radial direction R of the circle C. For this reason, when the wiper arm 11 is pivoted, in a state in which the washer liquid is drawn toward the inner wall of the connecting region E1 or E2 by the Coanda effect along any one of the curved surfaces 35, a flow of the washer liquid can be directed to a desired direction by the partition wall 36. Accordingly, when the configuration is employed, the washer liquid can more reliably flow along a desired ejection passage.

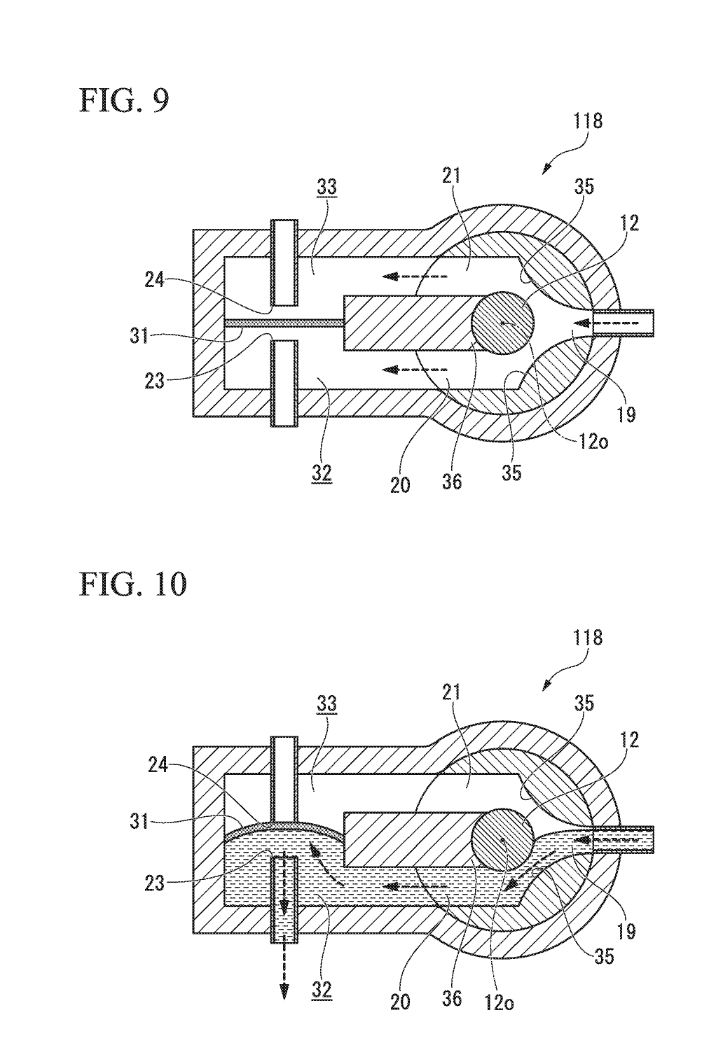

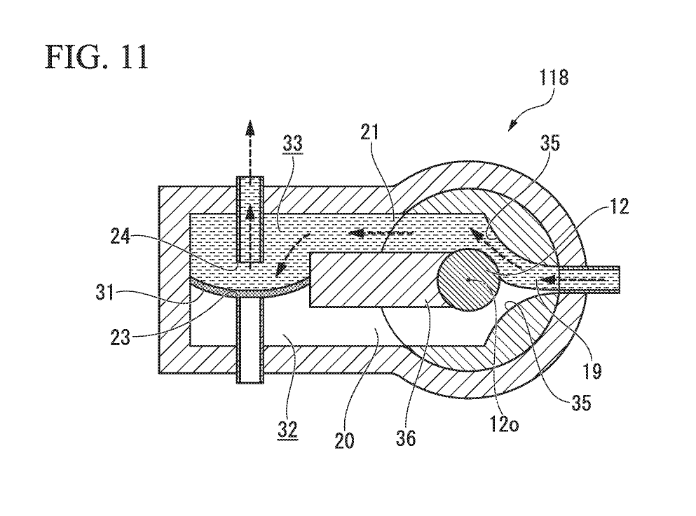

FIGS. 9 to 11 are views showing schematic cross sections of a distribution apparatus 118 of another embodiment. FIG. 9 shows a flow of the washer liquid in the distribution apparatus 118 when a pivoting direction of the wiper arm is reversed, and FIG. 10 shows a flow of the washer liquid in the distribution apparatus 118 when the wiper arm is pivoted in one direction. In addition, FIG. 11 shows a flow of the washer liquid in the distribution apparatus 118 when the wiper arm is pivoted in the other direction. Further, in FIGS. 9 to 11, common parts with the above-mentioned embodiment are designated by the same reference numerals.

The distribution apparatus 118 of the other embodiment shown in FIGS. 9 to 11 is installed in the wiper arm on the side of the base section. The distribution apparatus 118 has the partition wall 36 that divides the intake passage 19 into the first ejection passage 20 and the second ejection passage 21, and the pivot shaft 12 of the wiper arm is disposed on the tip portion of the partition wall 36. In the case of the embodiment, substantially the same effect as the above-mentioned embodiment can be obtained, and the distribution apparatus 118 can be compactly disposed on the wiper arm on the side of the base section.

Further, the present invention is not limited to the embodiments, and various modifications may be made thereto without departing from the scope of the present invention. For example, while the washer nozzle is attached to the wiper arm in the above-mentioned embodiments, the washer nozzle may be attached to the wiper blade or a plurality of washer nozzles may be attached to the wiper arm and the wiper blade. In addition, the washer device may be configured to wipe a glass surface other than a windshield glass of a vehicle.

While preferred embodiments of the invention have been described and illustrated above, it should be understood that these are exemplary of the invention and are not to be considered as limiting. Additions, omissions, substitutions, and other modifications can be made thereto without departing from the scope of the present invention. Accordingly, the invention is not to be considered as being limited by the foregoing description, and is only limited by the scope of the appended claims.

What is claimed is:

1. A vehicular washer device comprising:
a wiper arm that reciprocates in a circumferential direction of a circle about a pivot shaft installed in a vehicle;
a wiper blade held at the wiper arm and that wipes a target surface to be wiped of the vehicle;
a washer nozzle installed on at least one of the wiper arm and the wiper blade and that injects a washer liquid toward the target surface to be wiped;
a washer liquid passage that brings a supply part of the washer liquid and the washer nozzle in communication with each other; and
a distribution apparatus installed on a portion of the washer liquid passage and that reciprocates in the circumferential direction of the circle in a linked manner with the wiper arm,
wherein the distribution apparatus has:
an intake passage connected to the supply part of the washer liquid;
a first ejection passage disposed further outside in a radial direction of the circle than the intake passage and disposed at a position offset toward a first side in the circumferential direction with respect to the intake passage; and
a second ejection passage disposed further outside in the radial direction of the circle than the intake passage and disposed at a position offset with respect to a second side in the circumferential direction with respect to the intake passage, and
the washer nozzle is connected to at least one of the first ejection passage and the second ejection passage.

2. The vehicular washer device according to claim 1,
wherein different washer nozzles are connected to the first ejection passage and the second ejection passage, respectively.

3. The vehicular washer device according to claim 2,
wherein the washer nozzle connected to the first ejection passage is configured such that an injecting direction thereof is directed toward the second side in the circumferential direction of the circle, and
the washer nozzle connected to the second ejection passage is configured such that an injecting direction thereof is directed toward the first side in the circumferential direction of the circle.

4. The vehicular washer device according to claim 2,
wherein the distribution apparatus has a first outflow chamber and a second outflow chamber partitioned by a diaphragm and that are in communication with the first ejection passage and the second ejection passage, respectively,
a first outflow port to which one of the washer nozzles is connected is formed in the first outflow chamber, and a second outflow port to which the other washer nozzle is connected is formed in the second outflow chamber, and
the diaphragm alternatively closes the first outflow port and the second outflow port according to a deform displacement of the diaphragm.

5. The vehicular washer device according to claim 3,
wherein the distribution apparatus has a first outflow chamber and a second outflow chamber partitioned by a diaphragm and that are in communication with the first ejection passage and the second ejection passage, respectively,
a first outflow port to which one of the washer nozzles is connected is formed in the first outflow chamber, and a second outflow port to which the other washer nozzle is connected is formed in the second outflow chamber, and
the diaphragm alternatively closes the first outflow port and the second outflow port according to a deform displacement of the diaphragm.

6. The vehicular washer device according to claim 1,
wherein an inner wall of at least one of a connecting region from the intake passage to the first ejection passage and a connecting region from the intake passage to the second ejection passage is configured by a curved surface protruding toward a central side of a passage of the connecting region.

7. The vehicular washer device according to claim 1,
wherein the distribution apparatus comprises a partition wall configured to partition the first ejection passage and the second ejection passage, and
the partition wall is disposed on an extension line of the intake passage.
